(19) United States
(12) Patent Application Publication
(10) Pub. No.: US 2026/0197823 A1
(43) Pub. Date: Jul. 9, 2026

(54) METHOD FOR TREATING INTERFERENCE OF CO-SCHEDULED WIRELESS DEVICES

(71) Applicant: Telefonaktiebolaget LM Ericsson (publ), Stockholm (SE)

(72) Inventors: Hamed FARHADI, Stockholm (SE); Pål FRENGER, Linköping (SE)

(21) Appl. No.: 19/128,354

(22) PCT Filed: Nov. 9, 2022
(86) PCT No.: PCT/SE2022/051040

§ 371 Date: May 8, 2025

(51) Int. Cl. H04W 72/1268; H04B 7/06

(52) U.S. Cl. CPC H04W 72/1268; H04B 7/0626

(57) ABSTRACT

A method for configuring a network node for co-scheduled wireless devices (WD). A set of WDs from a plurality of WDs for co-scheduled uplink transmission is determined based on obtained uplink transmissions from the WDs. A measure of interference for each WD is determined, where the measure of interference indicates interference from uplink transmissions from the WD with respect to uplink transmissions from the remainder of WDs in the set. Each WD in the set is assigned into one of at least a first group and a second group, where WDs with respective measures of interference below a first threshold are assigned to the first group, and WDs with respective measures above a second threshold are assigned to the second group. The network node is configured to treat interference from at least one WD in the set based on the group to which the WD is assigned.

### TECHNICAL FIELD

The present disclosure relates generally to the field of wireless communication. More particularly, it relates to a network node and a method therein for configuring the network node for co-scheduled wireless devices in a wireless communications network. The present disclosure also relates to a computer program and a carrier.

### BACKGROUND

In multi-user (MU) communication networks, where multiple user equipments (UEs) in a cell intend to communicate with an intended base station (such as a gNB) over the same time and frequency resources, the received signals at the base station are subject to interference. Such inter-user interference degrades communication network performance. Inter-user interference may also arise from other UEs in other cells.

There have been several solutions in the literature to mitigate interference. For example, multiple antennas at the transmitters and receivers may be used to beamform transmit signals to avoid causing interference to other receivers than the intended receiver. Other strategies involve filtering the received signals to null the received interference.

A conventional technique to deal with interference is to treat interference as noise (TIN) and conduct the decoding of the desired signal. This technique is suitable when the interference has a lower signal strength compared to the desired signal.

Another technique to deal with interference is successive interference cancelation (SIC). In SIC-based decoding, the impact of interference is compensated for by first decoding the interference and thereafter removing the contribution of the interference from the received signal before decoding the desired signal. This technique is suitable when the interference has a relatively large signal strength compared to the desired signal.

Each of these techniques is suitable for specific circumstances. Identifying the best strategy to deal with interference is, however, an open problem.

### SUMMARY

It is an object of the present disclosure to mitigate, alleviate or eliminate one or more of the above-identified deficiencies and disadvantages in the prior art and solve at least the above-mentioned problem. In particular, an object is to provide improved wireless communications networks. More particularly, an object is to provide improved methods enabling co-scheduling of wireless devices in the wireless communications networks. These objects are obtained at least in part by a method performed by a network node in a wireless communications network for configuring the network node for co-scheduled wireless devices in the wireless communications network. The method comprises determining a set of wireless devices from a plurality of wireless devices in the wireless communications network for co-scheduled uplink transmission based on obtained uplink transmissions from the plurality of wireless devices. The method also comprises determining a measure of interference for each wireless device in the set. The measure of interference of a wireless device indicates interference from uplink transmissions from said wireless device with respect to uplink transmissions from the remainder of wireless devices in the set. The method further comprises assigning each wireless device in the set into one of at least a first group and a second group. Wireless devices with respective measures of interference below a first predetermined threshold are assigned to the first group. Wireless devices with respective measures of interference above a second predetermined threshold are assigned to the second group. The method also comprises configuring the network node to treat interference from at least one wireless device in the set based on the group to which said wireless device is assigned.

The disclosed method provides an improved performance of the wireless communications network in terms of e.g. throughput. Decisions taken by a scheduler in the wireless communications network, such as resource allocation, power, modulation and coding, affect the performance that may be achieved by different decoding strategies, such as decoding methods based on successive interference cancelation (SIC) or decoding methods based on treating interference as noise (TIN). The present disclosure therefore proposes a method that groups wireless devices that are co-scheduled for multi-user transmission over shared radio resource blocks in time and frequency. The co-scheduled wireless devices are divided into at least two groups (e.g. a TIN group and a SIC group). For each group, a decoding strategy for treating multi-user interference is selected based on that particular group. The disclosed method thus provides an appropriate application of receiver strategies to deal with inter-user interference depending on the scenario.

The disclosed method may further reduce radio resources (transmit power, spectrum) required for multi-user transmission. For instance, in the presence of severe interference, instead of increasing transmit power of the intended transmitter, the contribution of the interference may be removed before decoding the desired signal by performing SIC. Consequently, there will be no need for power boost to mitigate the interference. The disclosed method may therefore increase the performance of the wireless communications network in terms of e.g. energy efficiency.

According to some aspects, the method further comprises configuring the network node to decode uplink transmissions from a wireless device in the set where uplink transmissions from other wireless devices in the first group are treated as noise and where uplink transmissions from other wireless devices in the second group are managed using successive interference cancellation. Consequently, the first group may be called a TIN group and the second group may be called a SIC group. SIC-based decoding is particularly suitable for dealing with interference that is relatively strong, whereas TIN-based decoding is particularly suitable for dealing with interference that is relatively weak. Herein, a measure of interference below the first predetermined threshold may thus indicate relatively weak interference and a measure of interference above the second predetermined threshold may indicate relatively strong interference. The disclosed method provides a receiver strategy that deals with inter-user interference in an effective way. This may improve the performance of the wireless communications network in terms of e.g. throughput.

Furthermore, interfering uplink transmissions may be treated in other ways than by TIN-based methods or SIC-based methods. Another way of dealing with interference is by applying Han and Kobayashi (HK) coding at the transmitter side where each user splits its transmission rate between two sets of code words representing common and private messages. At the receiver side, the code words corresponding to the common messages and the private message of its corresponding transmitter are decoded. The receiver treats the code word representing the private message of the other user as noise.

According to some aspects, the measure of interference is based on any of channel state information, transmit power, relative location, and modulation and coding scheme of the wireless devices in the set. Any of these metrics may indicate interference alone or in combination.

According to some aspects, the assigning of wireless devices comprises assigning a wireless device in the set into a third group if the measure of interference of that wireless device is above the first predetermined threshold and is below the second predetermined threshold, where the first predetermined threshold is different from the second predetermined threshold. Interfering uplink transmissions from wireless devices in the third group may be treated differently during decoding compared to interfering uplink transmissions from wireless devices in the other groups.

According to some aspects, the method further comprises determining one or more transmit parameters of at least one wireless device in the set based on the group to which said wireless device is assigned, and communicating the one or more determined transmit parameters to the corresponding wireless devices in the set for co-scheduled uplink transmission. This way, the grouped wireless devices are adapted to be more compatible with the different decoding strategies. This may further improve performance of the wireless communications network in terms of e.g. throughput. Transmit parameters of the wireless devices may be adapted to make wireless devices belonging to the same group more compatible with the selected decoding strategy of that particular group. For example, more compatible may mean that wireless devices in a TIN group are adapted to decrease interference to other wireless devices in the set for co-scheduled transmission. Similarly, wireless devices in a SIC group may be adapted to increase interference to other wireless devices in the set for co-scheduled transmission.

According to some aspects, the method comprises iteratively assigning each wireless device in the set into one of the first, second, and third group based on the one or more determined transmit parameters, and determining one or more determined transmit parameters based on the group assignments. Here, the measure of interference is preferably also updated each time a transmit parameter is changed. The wireless devices are regrouped after transmit parameters of one or more wireless devices have changed. The iteration of the steps may make wireless devices belonging to the same group even more compatible with the selected decoding strategy of said group. This may further increase the performance of the wireless communications network, e.g. in terms of throughput. The assigning and determining steps may be iterated until the number of wireless devices assigned to each group converges. Alternatively, or in combination of, the assigning and determining steps may be iterated until the third group has a number of assigned wireless devices below a predetermined threshold.

According to some aspects, the one or more determined transmit parameters of a wireless device in the first group are determined to decrease the measure of interference of that wireless device, and wherein the one or more determined transmit parameters of a wireless device in the second group are determined to increase the measure of interference of that wireless device. This way, transmit parameters of the wireless devices are adapted to make wireless devices belonging to the same group more compatible with the selected decoding strategy of said group.

According to some aspects, the one or more determined transmit parameters of a wireless device in the third group are determined to decrease the measure of interference of that wireless device if that measure of interference is closer to the first predetermined threshold than the second predetermined threshold, and to increase the measure of interference of that wireless device if that measure of interference is closer to the second predetermined threshold than the first predetermined threshold. Wireless devices with an intermediate level of interference, i.e., a measure of interference between the first and the second predetermined thresholds, may be unsuitable for TIN-based decoding or SIC-based decoding. Thus, it may be desired to adapt the transmit parameters of the wireless devices in the third group such that their respective metrics of interference change in way so they may be regrouped to either the first group or the second group.

According to some aspects, one or more remaining wireless devices in the third group are removed from the set for co-scheduled uplink transmission. It may not be possible to adapt transmit parameters such that no wireless devices remain in the third group after regrouping. Thus, network performance may be improved if any remaining wireless device in the third group are rescheduled to a different time and/or frequency resource compared to the set of co-scheduled wireless devices.

According to some aspects, the one or more determined transmit parameters comprise any of transmit power, modulation and coding scheme, and a hardware parameter affecting any of digital-to-analog converter resolution, power amplifier linearity, and oscillator phase noise. Any of these metrics may affect the measure of interference alone or in combination.

According to some aspects, the one or more determined transmit parameters are communicated separately from a scheduling decision. The scheduling decision typically includes assigned time and frequency resources for the set of co-scheduled wireless devices. The scheduling decision may also include some parameters that are similar to the transmit parameters such as transmit power and MCS. Parameters like transmit power and MCS may be updated separately proceeding a communicated scheduling decision. In other words, a command to update transmit parameters may be communicated after a scheduling decision has been communicated. The transmit parameters may also include parameters not present in the scheduling decision, such as hardware parameters (e.g. bias voltages). In that case, the determined transmit parameters may be communicated at the same time but separately from a scheduling decision, or be communicated at a different time. If the transmit parameters comprise an update of information also present in the scheduling decision, communicating the transmit parameters separately from the scheduling decision may be advantageous if relatively minor changes of the transmit parameters are desired since this may require less computationally resources compared to a full rescheduling decision. This may also be beneficial in terms of latency. However, if relatively large changes of the transmit parameters are desired, a full rescheduling decision may be more desirable.

Alternatively, the one or more determined transmit parameters are communicated as part of a scheduling decision. In other words, the transmit parameters are determined before a scheduling decision is communicated, and the determined transmit parameters are communicated as part of the scheduling decision.

According to some aspects, the set of wireless devices for co-scheduled uplink transmission is determined based on a measure of compatibility for a predetermined number of wireless devices to be assigned to the set, where the measure of compatibility indicates a compatibility of co-scheduled uplink transmissions. This way, the grouping of wireless devices may be more effective. This may therefore further increase the performance of the wireless communications network, e.g. in terms of throughput.

For example, wireless devices above a predetermined threshold of the measure of compatibility may be assigned to the first set. Furthermore, wireless devices may be selected to the first set to maximize the measure of compatibility. For example, the mean or average value of the computed measure of compatibility for a group of wireless devices may be used. Here maximize may mean finding a global or local maximum. The measure of compatibility may be based on the mentioned measure of interference or on interference in general. In those cases, it may be desired to select wireless devices that strongly interfere with each other and wireless devices that weakly interfere with each other. In other words, wireless devices that cause either weak interference or strong interference to the other wireless devices may be co-scheduled. The strong interference may be dealt with by SIC-based decoding and the weak interference may be dealt with by TIN-based decoding. Interference of some intermediate level is undesired in the set since none of TIN- or SIC-based decoding are likely to be the optimal decoding strategy for such interference. A wireless device causing either high or low interference for other potentially co-scheduled wireless devices may be assigned a relatively high measure of compatibility.

According to some aspects, the set of wireless devices for co-scheduled uplink transmission is determined by assigning a first wireless device from the plurality of wireless devices to the set, and iteratively, until a predetermined number of wireless devices are assigned to the set, determining a measure of compatibility for each unassigned wireless device in the plurality of wireless devices, where the measure of compatibility of a wireless device indicates a compatibility of co-scheduled uplink transmissions from said wireless device with respect to uplink transmissions of the one or more wireless devices assigned to the set, and assigning a wireless device to the set based on the measure of compatibility. This provides a computationally efficient way of determining the set.

According to some aspects, the measure of compatibility is based on any of channel state information, transmit power, relative location, and modulation and coding scheme of the wireless devices. Any of these metrics may indicate compatibility alone or in combination.

There is also disclosed herein a network node for co-scheduled wireless devices in a wireless communications network. The node is associated with the above-discussed advantages. The node comprises a processing circuitry and a memory. The processing circuitry is configured to determine a set of wireless devices from a plurality of wireless devices in the wireless communications network for co-scheduled uplink transmission based on obtained uplink transmissions from the plurality of wireless devices. The processing circuitry is further configured to determine a measure of interference for each wireless device in the set, where the measure of interference of a wireless device indicates interference from uplink transmissions from said wireless device with respect to uplink transmissions from the remainder of wireless devices in the set. The processing circuitry is also configured to assign each wireless device in the set into one of at least a first group and a second group. Wireless devices with respective measures of interference below a first predetermined threshold are assigned to the first group, and wireless devices with respective measures of interference above a second predetermined threshold are assigned to the second group. The processing circuitry is further configured to configure the network node to treat interference from at least one wireless device in the set based on the group to which said wireless device is assigned.

There is also disclosed herein a computer program product comprising instructions which, when executed on at least one processing circuitry, cause the at least one processing circuitry to carry out the method according to the discussion above. The computer program is associated with the above-discussed advantages.

There is also disclosed herein a computer program carrier carrying a computer program product according to the discussion above, wherein the computer program carrier is one of an electronic signal, optical signal, radio signal, or computer-readable storage medium. The computer program carrier is associated with the above-discussed advantages.

### BRIEF DESCRIPTION OF THE DRAWINGS

With reference to the appended drawings, below follows a more detailed description of embodiments of the present disclosure cited as examples. In the drawings:

FIGS. 1A and 1B are schematic illustrations of wireless communications networks;

FIGS. 2-4 are flow charts illustrating methods;

FIG. 5 schematically illustrates a network node;

FIG. 6 shows an example of a communication system in accordance with some embodiments;

FIG. 7 is a block diagram of a host, which may be an embodiment of the host 6 of FIG. 6, in accordance with various aspects described herein; and

FIG. 8 shows a communication diagram of a host communicating via a network node with a UE over a partially wireless connection in accordance with some embodiments.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

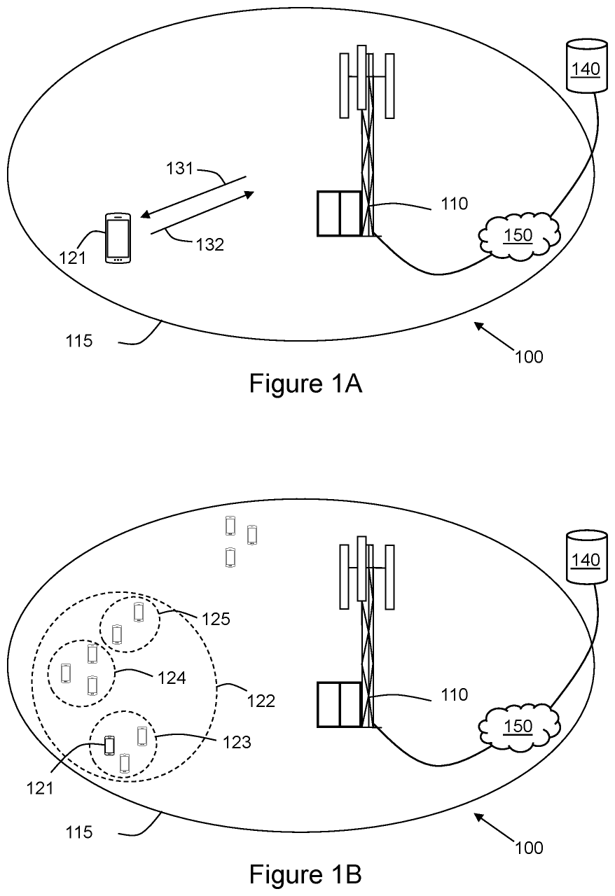

FIG. 1A depicts a wireless communications network 100 in which embodiments herein may operate. In some embodiments, the wireless communications network 100 may be a radio communications network, such as, 6G, NR or NR+ telecommunications network. However, the wireless communications network 100 may also employ technology of any one of 3/4/5G, LTE, LTE-Advanced, WCDMA, GSM/EDGE, WiMax, UMB, GSM, or any other similar network or system. The wireless communications network 100 may also employ technology transmitting on millimeter-waves (mmW), such as, e.g. an Ultra Dense Network, UDN. In some embodiments, the wireless communications network 100 may also employ transmissions supporting WiFi transmissions, e.g. the wireless communications standard IEEE 802.11ad or similar, or other non-cellular wireless transmissions.

The wireless communications network 100 comprises a network node 110. The network node 110 may serve wireless devices in at least one cell 115, or coverage area. The network node 110 may correspond to any type of network node or radio network node capable of communicating with a wireless device and/or with another network node, such as, a base station (BS), a radio base station, gNB, eNB, eNodeB, a Home NodeB, a Home eNodeB, a femto Base Station (BS), or a pico BS in the wireless communications network 100. Further examples of the network node 110 may be a repeater, multi-standard radio (MSR) radio node such as MSR BS, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), or core network node. The network node 110 may be arranged to communicate with a remote data processing unit 140 via a core network 150 of the wireless communications network 100. The remote data processing unit 140 may, for example, be a remote standalone server, a cloud-implemented server, a distributed server, dedicated data processing resources in a server farm, or similar.

Furthermore, in FIG. 1A, a wireless device 121 is located within the cell 115. The wireless device 121 is configured to communicate within the wireless communications network 100 via the network node 110 over a radio link served by the network node 110. The wireless device 121 may transmit data over an air or radio interface to the radio base station 110 in uplink (UL) transmissions 132 and the radio base station may transmit data over an air or radio interface to the wireless device 121 in downlink (DL) transmissions 131. The wireless device 121 may refer to any type of wireless device or user equipment (UE) communicating with a network node and/or with another wireless device in a cellular, mobile or radio communication network or system. Examples of such wireless devices are mobile phones, cellular phones, personal digital assistants (PDAs), smart phones, tablets, sensors equipped with a UE, laptop mounted equipment (LME) (e.g. Universal Serial Bus, USB), laptop embedded equipment (LEE), machine type communication (MTC) devices, or machine to machine (M2M) device, customer premises equipment (CPE), target device, device-to-device (D2D) wireless device, wireless device capable of machine to machine (M2M) communication.

As part of the developing of the embodiments described herein, it has been realized that wireless devices may be grouped together in different groups where interference in different groups are treated differently during decoding of uplink transmissions from the wireless devices. Decisions taken by the scheduler in the wireless communications network, such as resource allocation, power, modulation and coding, affect the performance that may be achieved by different decoding strategies, such as SIC-based decoding methods or TIN-based decoding methods. The present disclosure therefore proposes a method that groups and co-schedule compatible wireless devices for multi-user transmission over shared radio resource blocks. Co-scheduled wireless devices are divided into at least two groups (e.g. a TIN group and a SIC group). For each group, a decoding strategy for treating multi-user interference is selected based on that particular group. The application of an appropriate receiver strategy to deal with inter-user interference depending on the scenario in the disclosed method thus provides an increased performance of the wireless communications network, in terms of e.g. throughput.

Optionally, transmit parameters of the wireless devices are be adapted to make wireless devices belonging to the same group more compatible with the selected decoding strategy of that particular group. The scheduling decision and/or grouping may be iterated until a final scheduling and grouping is obtained, which is communicated to the wireless devices in the wireless communications network. The disclosed method thus provides flexibility to deal with interference by co-scheduling wireless devices for which the resulting interference is more compatible with the receiver strategies.

The methods disclosed herein may reduce radio resources (transmit power, spectrum) required for multi-user transmission. For instance, in the presence of severe interference, instead of increasing transmit power of the intended transmitter, the contribution of the interference may be removed before decoding the desired signal by performing SIC. Consequently, there will be no need for power boost to mitigate the interference. The disclosed method therefore may increase the performance of the wireless communications network in terms of e.g. energy efficiency.

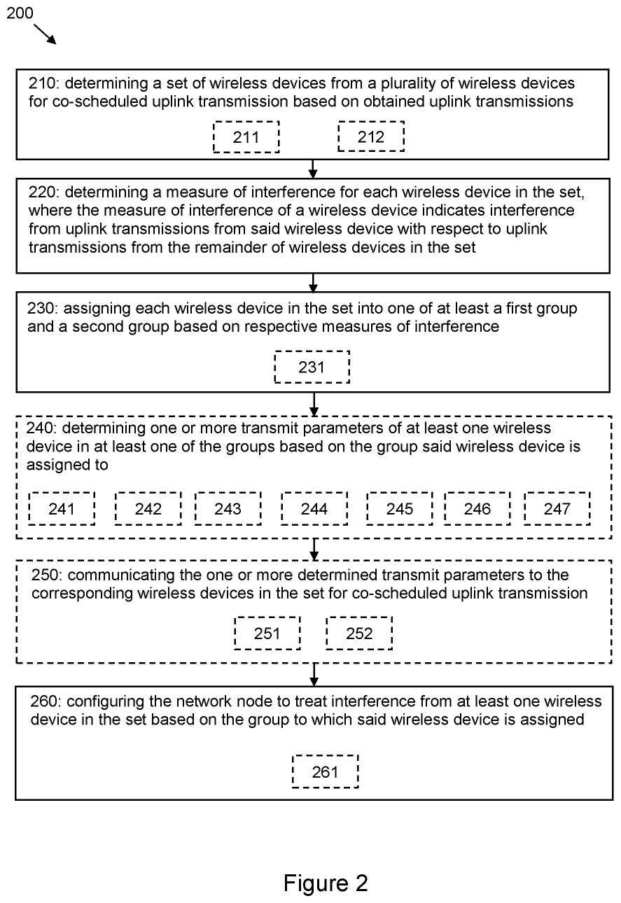

To summarize, there is disclosed herein a method 200 performed by a network node 110 in a wireless communications network 100 for configuring the network node for co-scheduled wireless devices 121 in the wireless communications network. In particular, the network node may be configured to decode uplink transmissions from the co-scheduled wireless devices. FIG. 1B shows a schematic illustration of a wireless communications network in which different wireless devices have been grouped in different groups. FIG. 2 shows a flow chart of the disclosed method.

The method comprises several actions, which are discussed below.

Action 210. The method comprises determining a set 122 of wireless devices 121 from a plurality of wireless devices in the wireless communications network 100 for co-scheduled uplink transmission based on obtained uplink transmissions from the plurality of wireless devices. The set comprises two or more wireless devices. FIG. 1B shows eleven wireless devices 121, where eight have been assigned to the set 122.

In an example embodiment, wireless devices are co-scheduled for uplink transmission over shared radio resource blocks using a measure of compatibility. The measure of compatibility quantifies if the wireless devices are suitable to be co-scheduled, e.g. in terms of introduced interference to each other. In other words, the set 122 of wireless devices 121 for co-scheduled uplink transmission may be determined 211 based on a measure of compatibility for a predetermined number of wireless devices to be assigned to the set, where the measure of compatibility indicates a compatibility of co-scheduled uplink transmissions.

For example, wireless devices with a measure of compatibility above a predetermined threshold may be assigned to the first set. Furthermore, wireless devices may be selected to the set to maximize the measure of compatibility. In that case, the mean or average value of the computed measure of compatibility for a group of wireless devices may be used. Here maximize may mean finding a global or local maximum.

The compatibility may be based on interference. In that case, it may be desired to select wireless devices that strongly interfere with each other and wireless devices that weakly interfere with each other. In other words, wireless devices that cause either weak interference or strong interference to the other wireless devices may be co-scheduled. The strong interference may be dealt with by SIC-based decoding and the weak interference may be dealt with by TIN-based decoding. Interference of some intermediate level is undesired in the set since none of TIN- or SIC-based decoding are likely to be the optimal decoding strategy for such interference. Both high and low interference may result in a high measure of compatibility.

In one example embodiment, where a gNB and UEs use multi-antenna systems, the measure of compatibility is computed based on the distance between the spatial sub-spaces associated to the UEs. Although any type of network node or wireless device may be used in the methods herein, UEs and gNBs are used as examples. The measure of compatibility may thus be based on the UEs respective positions relative to the each other and/or to the gNB. This may be measured determining the inner product of the normalized channel state information (CSI) vectors associated to the corresponding UEs. In that case, a large value implies that the subspaces are more aligned and hence there would be more interference while a small value is corresponding to the cases that the sub spaces are close to be orthogonal and hence there would be less interference.

In another example, the relative power of the intended signal to that of the interference signal may be used for the measure of compatibility. The measure of compatibility may alternatively, or in combination of, be computed using parameters including the estimated CSI, UE transmit power, and the selected modulation and coding scheme (MCS) indices of the UEs.

In another example embodiment, the set of compatible UEs for transmission over a given resource block may be iteratively constructed as follows:
1. Select one of the UEs from all available UEs in the wireless communications network.
2. Select the second UE from the remaining UEs that has the highest compatibility measure with the first UE in the selected set.
3. Select the next UE from the remaining UEs that has the highest average or sum compatibility measure with the existing UEs in the selected set.
4. Continue step 3 until the maximum number of co-scheduled UEs is reached.

In other words, the set 122 of wireless devices 121 for co-scheduled uplink transmission may be determined 212 by assigning a first wireless device 121 from the plurality of wireless devices to the set 122, and iteratively, until a predetermined number of wireless devices are assigned to the set, determining a measure of compatibility for each unassigned wireless device 121 in the plurality of wireless devices, where the measure of compatibility of a wireless device indicates a compatibility of co-scheduled uplink transmissions from said wireless device with respect to uplink transmissions of the one or more wireless devices assigned to the set 122, and assigning a wireless device 121 to the set 122 based on the measure of compatibility.

Alternatively, the selection of compatible wireless devise to the set may be formulated as an optimization problem, in which the objective may be the maximization of measure of compatibility for the wireless devices (or the minimum, sum, or average value of the measure across different wireless devices). The optimization problem may e.g. be solved using different optimization techniques such as non-linear programming algorithms, iterative genetic algorithm, or nonlinear optimization methods such as neural networks to determine the set of co-scheduled wireless devices.

Action 220. The method comprises determining a measure of interference for each wireless device 121 in the set 122, where the measure of interference of a wireless device indicates interference from uplink transmissions from said wireless device with respect to uplink transmissions from the remainder of wireless devices in the set 122.

For example, the received signal strength at the network node from each wireless device in the set may be used as a measure of interference. The received signal strength may be obtained from transmit power and path loss. The measure of interference may be said received signal strength normalized with the highest received signal strength. In that case, a measure of interference below 50% may be considered a low value of interference and a measure of interference above 50% may be considered a high value of interference.

In a further example, wireless devices with a measure of interference below 20% (according to the previous paragraph) or a measure of interference above 80% may be considered having a high measure of compatibility.

The measure of interference may be the same or may be based on the measure of compatibility, or vice versa. The two metrics may alternatively be independent of each other. In general, the measure of interference may also be based on any of channel state information, transmit power, relative location, and modulation and coding scheme of the wireless devices 121 in the set 122. Even if the measure of interference is based on similar data as the measure of compatibility, the measure of interference may be expressed in different ways. For example, wireless devices with high or low measures of interference may have a high measure of compatibility.

Action 230. The method comprises assigning each wireless device 121 in the set 122 into one of at least a first group 123 and a second group 124. Wireless devices with respective measures of interference below a first predetermined threshold are assigned to the first group, and wireless devices with respective measures of interference above a second predetermined threshold are assigned to the second group. The first and the second predetermined thresholds may be different values, but may alternatively be the same value. A measure of interference below the first predetermined threshold may indicate relatively weak interference and a measure of interference above the second predetermined threshold may indicate relatively strong interference.

If the measure of interference is received signal strength normalized with the highest received signal strength, as discussed above, the first and second predetermined thresholds may be 50%.

Action 260. The method comprises configuring the network node 110 to treat interference from at least one wireless device 121 in the set 122 based on the group 123, 124 to which said wireless device is assigned. During decoding of an uplink transmissions from a first wireless device in the set, uplink transmissions from a second (different) wireless device in the set are treated based on the group 123, 124 to which the second wireless device is assigned. Here, “treating” means applying a predetermined decoding strategy, such as SIC-based decoding or TIN-based decoding. In other words, interfering uplink transmissions (i.e. other uplink transmissions than the desired one during the same time and frequency resource) are dealt with based on the group to which the wireless device transmitting the interfering uplink is assigned.

The method may further comprise configuring 261 the network node to decode uplink transmissions from a wireless device 121 in the set 122 where (interfering) uplink transmissions from other wireless devices in the first group 123 are treated as noise and where (interfering) uplink transmissions from other wireless devices in the second group 124 are managed using successive interference cancellation. Here, “managed using interference cancellation” means that the impact of interference is compensated for by first decoding the interference and thereafter removing the contribution of the interference from the received signal before decoding the desired signal. In other words, uplink transmissions from wireless devices in the second group are removed using successive interference cancellation. Here, “removed” does not necessarily mean a complete removal.

The assigning of wireless devices 121 may comprise assigning 231 a wireless device in the set 122 into a third group 125 if the measure of interference of that wireless device is above the first predetermined threshold and is below the second predetermined threshold, where the first predetermined threshold is different from the second predetermined threshold. Interfering uplink transmissions from wireless devices in the third group may treated differently during decoding compared to the other groups. Furthermore, as is described in more detail below, the disclosed method may comprise further steps to adapt the wireless devices in the third group such that they may be re-assigned into the first or the second group. Alternatively, one or more wireless devices in third group may be removed from the set for co-scheduled transmission.

Action 240. The method may comprise determining one or more transmit parameters of at least one wireless device 121 in the set 122 based on the group 123, 124, 125 to which said wireless device is assigned. This provides flexibility to deal with interference (in e.g. dense scenarios using massive antenna systems) by co-scheduling wireless devices for which the resulting interference is more compatible with the receiver strategies. Transmit parameters of the wireless devices are adapted to make wireless devices belonging to the same group more compatible with the selected decoding strategy of said group. Here, more compatible may mean that wireless devices in a TIN group are adapted to decrease interference to other wireless devices in the set for co-scheduled transmission. Similarly, wireless devices in a SIC group may be adapted to increase interference to other wireless devices in the set for co-scheduled transmission. In other words, the one or more determined transmit parameters of a wireless device 121 in the first group 123 may be determined 244 to decrease the measure of interference of that wireless device, and the one or more determined transmit parameters of a wireless device in the second group 124 may be determined 245 to increase the measure of interference of that wireless device.

In general, a transmit parameter may be any parameter affecting the measure of interference. For example, the one or more determined transmit parameters may comprise any of transmit power, modulation and coding scheme, and a hardware parameter affecting any of digital-to-analog converter (DAC) resolution, power amplifier (PA) linearity, and oscillator phase noise. The hardware parameter is parameter that affects the hardware of a wireless device. In particular, bias and/or supply voltages for various components, such as PAs, mixers, oscillators etc. Parameters such as bias and supply particularly affect PA linearity and oscillator phase noise.

Optionally, the method comprises iteratively assigning each wireless device 121 in the set 122 into one of the first, second, and third group 123, 124, 125 based on the one or more determined transmit parameters, and determining 241 one or more determined transmit parameters based on the group assignments. Here, the measure of interference is preferably also updated each time a transmit parameter is changed. The wireless devices are regrouped after transmit parameters of one or more wireless devices have changed. If e.g. the transmit power of a first wireless device is changed, that wireless device may be reassigned into a different group according to an updated measure of interference. Measures of interference for other wireless devices may also change when a transmit parameter is changed for the first wireless device.

For example, if the measure of interference is based on transmit power, and if the transmit parameter comprises transmit power, an update of the measure of interference may be calculated directly from an update of the transmit parameter. If the transmit parameter comprises parameters like bias voltages, an update of the measure of interference may be obtained from a table comprising information of how such transmit parameter affects the measure of interference.

During the iterations above, the set of wireless devices for co-scheduled transmission may be fixed. However, the assigning into the groups may also be done iteratively together with selection of the set of wireless devices for co-scheduled transmission. The iteration of the grouping steps may make wireless devices belonging to the same group even more compatible with the selected decoding strategy of said group. Including the selection steps in the iterations may further make wireless devices belonging to the same group more compatible with the selected decoding strategy of said group.

The assigning and determining steps may be iterated 242 until the number of wireless devices assigned to each group converges. For example, if there is no change in assignments for two or more consecutive iterations, the process may be deemed to have converged. Alternatively, the assigning and determining steps may be iterated 243 until the third group has a number of assigned wireless devices below a predetermined threshold. There may be other stop criteria as well, such as when the signal from all transmitters may be successfully decoded.

The one or more determined transmit parameters of a wireless device 121 in the third group 125 may be determined 246 to decrease the measure of interference of that wireless device if that measure of interference is closer to the first predetermined threshold than the second predetermined threshold, and to increase the measure of interference of that wireless device if that measure of interference is closer to the second predetermined threshold than the first predetermined threshold. Wireless devices with an intermediate level of interference, i.e., a measure of interference between the first and the second predetermined thresholds, may be unsuitable for TIN-based decoding or SIC-based decoding. Thus, it may be desired to adapt the transmit parameters of the wireless devices in the third group such that their respective metrics of interference change in a way so they may be regrouped to either the first group or the second group.

One or more remaining wireless devices 121 in the third group 125 may be removed 247 from the set 122 for co-scheduled uplink transmission. It may not be possible to adapt transmit parameters such that no wireless devices remain in the third group after regrouping. Therefore, network performance may be improved if any remaining wireless device in the third group are rescheduled to a different time and/or frequency resource compared to the set of co-scheduled wireless devices.

Action 250. The method may further comprise communicating the one or more determined transmit parameters to the corresponding wireless devices 121 in the set 122 for co-scheduled uplink transmission.

The one or more determined transmit parameters may be communicated 252 separately from a scheduling decision. The scheduling decision typically includes assigned time and frequency resources for the set of co-scheduled wireless devices. The scheduling decision may also include some parameters that are similar to the transmit parameters such as transmit power and MCS. Parameters like transmit power and MCS may be updated separately proceeding a communicated scheduling decision. In other words, a command to update transmit parameters may be communicated after a scheduling decision has been communicated. The transmit parameters may also include parameters not present in the scheduling decision, such as hardware parameters (e.g. bias voltages). In that case, the determined transmit parameters may be communicated at the same time but separately from a scheduling decision, or be communicated at a different time. If the transmit parameters comprise an update of information also present in the scheduling decision, communicating the transmit parameters separately from the scheduling decision may be advantageous if relatively minor changes of the transmit parameters are desired since this may require less computationally resources compared to a full rescheduling decision. This may also be beneficial in terms of latency. However, if relatively large changes of the transmit parameters are desired, a full rescheduling decision may be more desirable. Thus, the one or more determined transmit parameters may be communicated 251 as part of a scheduling decision. In other words, the transmit parameters are determined before a scheduling decision is communicated, and the determined transmit parameters are communicated as part of the scheduling decision.

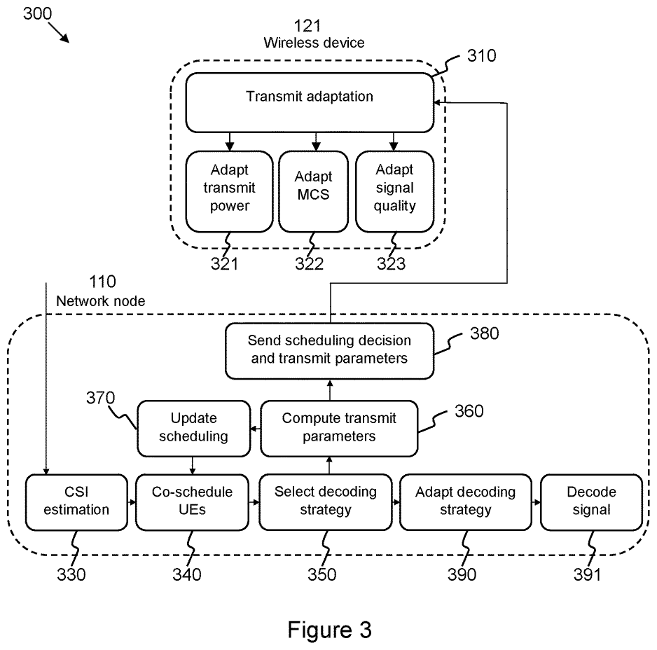

FIG. 3 shows an example method 300 of co-scheduling UEs for multi-user transmission. In particular, the figure shows a method in gNB that co-schedules compatible UEs for multi-user transmission over shared resource blocks, selects a decoding strategy for treating interference, and adapts UE transmit parameters to make co-scheduled UEs more compatible according to the selected decoding strategy.

At step 330, the gNB (or more generally network node 110) receives pilot signals from the UEs (or more generally wireless devices 121) in the wireless communications network 100 and performs a CSI estimation. At step 340, the gNB makes a first scheduling decision. This includes determining the set of UEs for co-scheduled transmission. It may also include determining first transmit parameters for the UEs. The first scheduling decision may e.g. be based on previous scheduling decisions. At step 350, the UEs in the set are grouped into a TIN group (first group), a SIC group (second group), or a MIX group (third group) based on calculated respective measures of interference. Thereafter, at step 360, updated transmit parameters are computed based on the grouping of the wireless devices. At step 370, the scheduling decision is updated based on the updated transmit parameters. Steps 340, 350, 360, and 370 may be iterated according to the discussions above. When the iteration stops, the latest scheduling decision including the latest transmit parameters are sent the UEs the set. At step 390, the gNB adapts a decoding strategy according to the latest grouping. Thereafter, uplink transmissions may be decoded at step 391. The UEs 121 receive the latest scheduling with the latest transmit parameters and adapt accordingly at step 310. The one or more determined transmit parameters are in this example communicated as part of the scheduling decision. The updated transmit parameters may e.g. be adapting transmit power 321, adapting MCS 322, and/or adapting signal quality 323. The signal quality may e.g. be adapted via the hardware parameter discussed above.

In the grouping step 350, the measure of interference is computed for each UE with a value in the range of zero to one based on the relative strength of the interference to the intended signal. The measure of interference is used to measure the likelihood of UE belonging to any of the TIN group, MIX group, or SIC group. Values lower than a threshold T1 are corresponding to the cases that the UE belongs to TIN group, the values larger than a threshold T2 are corresponding to the cases that the UE belongs to SIC group, and the values larger than T1 and smaller than T2 are corresponding to the UEs belonging to MIX group.

In one example embodiment the transmit parameters for the UEs are adjusted so that the UEs may be made more interference compatible according to either TIN or SIC decoding strategy. This would result in operations leading the measure of interference from step 350 to become closer to zero or one values.

For example, the transmit power of the UEs in the MIX group for which the measure of interference is larger than T1 and smaller than T2 may be adapted as follows
If the compatibility measure is close to T1, then the transmit power is increased to make the UE become eligible to be added to the TIN group.
If the compatibility measure is close to T2, then the transmit power is decreased to make the UE become eligible to join the SIC group.

The grouping and the computed measures of interference are likely affected by the updated transmit parameter settings. For example, an increase of transmit power for a UE increases the interference to the other UEs. Therefore, if the groping is updated, some of the UEs from the TIN group may move to the MIX group or the SIC group, and some of the UEs in the MIX group may move to the SIC group. Also, a decrease in the transmit power of a UE may move some of the UEs from the SIC group to the MIX group, or even SIC group, and move some UEs from MIX group to TIN group. Therefore, the grouping and the measures of interference should be updated. The transmit power update and grouping update may continue iteratively until it converges, e.g. the grouping of the UEs does not change anymore.

The transmit parameters of the UEs in the MIX group may be adapted. For example, hardware parameters controlling the signal quality such as DAC resolution, PA nonlinearity, and oscillator phase noise may be adapted. If the measure of interference is close to T1, then the transmit parameters may be tuned (e.g. to increase DAC resolution, to apply PA input power back-off to reduce nonlinear operation of PA, or to increase oscillator bias power to reduce phase noise) so that the signal quality is improved and to make the UE become eligible to join the TIN group.

The MCS of the interfering UEs for the UEs in SIC group may be adapted to increase the chances that the signal from the interfering UEs in the SIC decoding strategy may be decoded successfully. Hence, an error propagation in the SIC operation may be avoided. Thus, the MCS of the UEs that contribute to interference to the UEs in SIC group may be reduced to ensure successful decoding of interfering signals.

Preferably, some of the UEs from the MIX group move either to the TIN group or to the SIC group depending on the value of the measure of interference. The scheduling decision may be updated by excluding the UEs that remain in the MIX group after updating the transmit parameters from the set of co-scheduled UEs over the selected resource block. The excluded UEs may then be assigned to another set of co-scheduled UEs for transmission over a separate resource block.

The gNB may inform the UEs about the selected transmit parameters using a control channel.

The UE adapts transmission following the recommendations from gNB. Some example adaptations of UE transmit parameters are as follows:
Increase UE transmit power by a value DP1, if the UE is in MIX group and the measure of interference is close to threshold T1.
Reduce UE transmit power by a value DP2, if the UE is in MIX group and the measure of interference is close to threshold T2.
Increase UE transmit signal quality if the measure of interference is close to T1 by applying one of the following techniques: increase DAC resolution; apply PA input power back off; and increase oscillator bias power.
Reduce the MCS index of UEs that contribute to interference to UEs in SIC group.

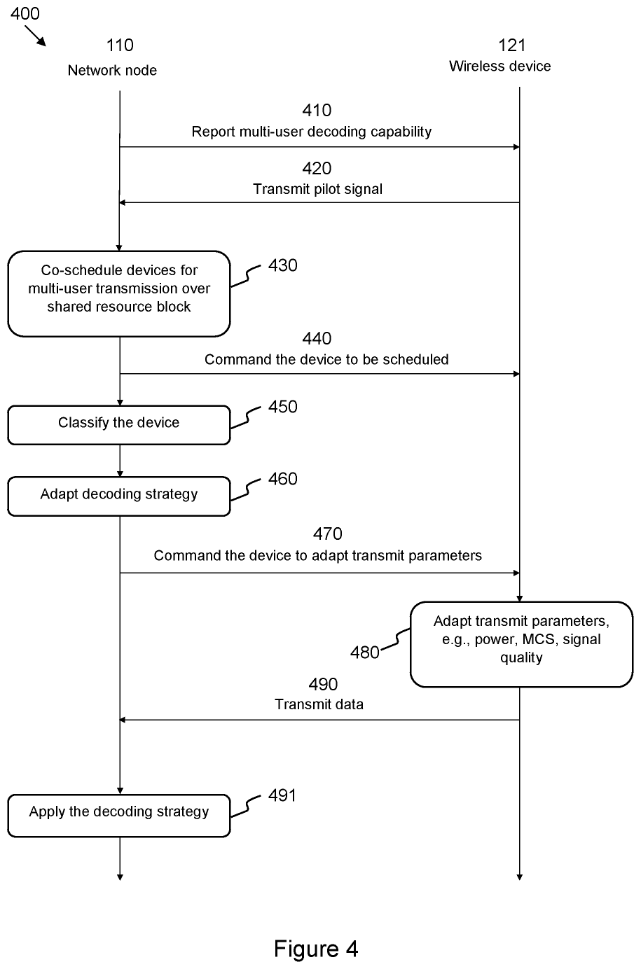

FIG. 4 shows an example method 400 of selecting decoding strategy for multi-user detection. In particular, the figure shows a method in gNB where the decoding strategy for each of the scheduled UEs is selected based on the interference characteristics relative to the intended signal. Here, the scheduled UEs are scheduled for multi-user transmission over shared resource blocks. The decoding strategy deals with the interference from each interfering user, by either treating the interference as noise or by performing successive interference cancellation while decoding the signal from the intended UE.

At step 410, a gNB (or more generally receiver node 110) reports its multi-user decoding capability to a plurality of UEs (or more generally wireless devices 121). At step 420, the UEs transmit respective pilot signals to the gNB. The gNB thereafter co-schedules at least some of the UEs for multi-user transmission over shared resource blocks at step 430. The co-scheduling may be based on the measure of compatibility discussed above. The co-scheduling may be done in other ways as well. At step 440, the gNB communicates the scheduling decision to UEs. This scheduling decision includes the set of UEs for co-scheduled transmission. At step 450, the UEs in the set are grouped into a TIN group (first group), a SIC group (second group), or a MIX group (third group). At step 460, the gNB adapts a decoding strategy according to the grouping. Thereafter, at step 470, adaptations of transmit parameters are computed and communicated to the UEs. The UEs 121 receives the transmit parameter adaptation command and adapts accordingly at step 480. The one or more determined transmit parameters are in this example communicated separate from the scheduling decision. The updated transmit parameters may e.g. be transmit power, MCS, and/or parameters affecting signal quality. The signal quality may e.g. be adapted via the hardware parameter discussed above. Thereafter, uplink transmissions are transmitted at step 490 and decoded at step 491.

Here, the scheduling decision includes information that may also be used as transmit parameters, such as transmit power and MCS. Thus, one or more transmit parameters that comprise information that is included in the scheduling decision may be adapted at step 480. However, other transmit parameters that do not comprise information used in the scheduling decision may be updated in combination or as an alternative. Such transmit parameters may be PA bias etc.

At step 450, the measure of interference is used to quantify the strength of the interference signal power relative to the intended signal power, where, depending on the computed measure, the UE is assigned to any of the following three groups:
A TIN group for which the interference is weak and hence is treated as noise.
A SIC group for which interference is strong and hence successive interference cancelation is applied to decode the desired signal in the presence of interference.
A MIX group for which the interference has moderate strength and hence neither of these decoding strategies is desirable.

The measure of interference is computed for each UE with a value in the range of zero to one based on the relative strength of the interference to the intended signal. The metric is used to measure the likelihood of UE belonging to either of the TIN group, MIX group, or SIC group, where the values lower than a threshold T1 are corresponding to the cases that the UE belongs to TIN group, the values larger than a threshold T2 are corresponding to the cases that the UE belongs to SIC group, and the values larger than T1 and smaller than T2 are corresponding to the UEs belonging to MIX group.

As mentioned, the grouping, and the computed measures of interference are likely affected by the updated transmit parameter settings. Therefore, the grouping and the computed measures of interference may be updated. The transmit power update and grouping update continue iteratively until it converges, e.g. the grouping of the UEs does not change anymore. The adaptation of the transmit parameters may be done in similar ways as discussed above in connection to FIG. 3.

Overall, the network node 110 may report its multi-user decoding capability to the wireless devices in the wireless communications network 100, command the wireless devices to be co-scheduled for transmission, and command the wireless devices to adapt respective one or more transmit parameters. The wireless device may activate transmission following the command from network node, and adapt the one or more transmit parameters following the command from network node.

An example implementation of the disclosed method is presented below. The example considers an UL scenario in a network with a gNB and three UEs (UE1, UE2, UE3), where the different strategies may be conducted for decoding of the received signal from UE1 by either treating the signal from UE2 and UE3 as noise or performing SIC or a combination of these. In this example, to be able to apply each of these decoding strategies, certain conditions need to be satisfied as the ones listed in Table I below. The received signal y₁ at the gNB may be modeled as follows

$${y}_{1} = {h}_{11} {x}_{1} + {h}_{12} {x}_{2} + {h}_{13} {x}_{3} + n ,$$

where xᵢ represents the transmitted signal by the i:th UE and h₁ᵢ represents the channel from the i:th UE to gNB (i∈{1,2,3}), and n is the receiver noise with power N₀. In Table I, pᵢ is the transmit power of signal xᵢ, and Rᵢ is the data rate from the i:th UE.

In this example, it is desired to decode the signal from UE1 while the signal from UE2 and UE3 are treated as interference. The interfering UEs (UE3 and UE2 in this example) are classified in two groups (TIN or SIC) based on conditions specified in column “conditions on interference”, where the conditions depend on the channel state information, transmit powers, and transmission rates (MCS indices).

For each classification of the UEs, a specific decoding strategy may be applied as specified in column “Decoding strategy”. The maximum rate for UE1 may be specified based on the decoding strategy that may be applied. The transmit parameters, e.g., transmit power, or MCS index may be adapted according to the discussions above such that the “conditions on interference” listed in Table I to be fulfilled. As mentioned, UE2 and UE3 can belong to either TIN or SIC group. In Table I, each row represents one of the five possibilities for treating UE2 and UE3 signals. For each case, the conditions on the interfering signals are specified. The conditions can be checked, and depending on which of these conditions are fulfilled, the corresponding decoding strategy for UE2 and UE3 can be selected. For each decoding strategy for interfering signals, the maximum rate that can be achieved for UE1 is shown (the last column). In the column “conditions on interference”, |h₁₂|²p₂ and |h₁₃|²p₃ are the interference power from interfering UEs, and there are two inequalities for each row in this column. These inequalities specify the conditions that the interfering signals from UE2 and UE3 respective to the signal from the intended UE, i.e., |h₁₁|²p₁, need to fulfil.

TABLE I
Example implementation of the disclosed method.

| | | | | Transmit | Maximum |
|---|---|---|---|---|---|
| Interfering | | Decoding | Conditions on | parameter | transmission rate |
| UE classes | | strategy | interference | adaptation | of UE1 |
| TIN UE2 UE3 | SIC | Decode the received message for | ${R}_{3} > {log}_{2} ( 1 + \frac{{\vert {h}_{13} \vert}^{2} {p}_{3}}{{\vert {h}_{12} \vert}^{2} {p}_{2} + {\vert {h}_{11} \vert}^{2} {p}_{1} + {N}_{0}} )$ | Adapt p₁, p₂, p₃ and MCS index | ${R}_{1} < {log}_{2} ( 1 + \frac{{\vert {h}_{11} \vert}^{2} {p}_{1}}{{\vert {h}_{12} \vert}^{2} {p}_{2} + {\vert {h}_{13} \vert}^{2} {p}_{3} + {N}_{0}} )$ |
| | | UE1 by treating the interference | ${R}_{2} > {log}_{2} ( 1 + \frac{{\vert {h}_{12} \vert}^{2} {p}_{2}}{{\vert {h}_{13} \vert}^{2} {p}_{3} + {\vert {h}_{11} \vert}^{2} {p}_{1} + {N}_{0}} )$ | for UE2, UE3 to fulfill | |
| | | from UE2 | | conditions | |
| | | and UE3 as | | on inter- | |
| | | noise. | | ference | |
| UE2 | UE3 | Decode the received message | ${R}_{3} < {log}_{2} ( 1 + \frac{{\vert {h}_{13} \vert}^{2} {p}_{3}}{{\vert {h}_{12} \vert}^{2} {p}_{2} + {\vert {h}_{11} \vert}^{2} {p}_{1} + {N}_{0}} )$ | Adapt p₁, p₂, p₃ and MCS index | ${R}_{1} < {log}_{2} ( 1 + \frac{{\vert {h}_{11} \vert}^{2} {p}_{1}}{{\vert {h}_{12} \vert}^{2} {p}_{2} + {N}_{0}} )$ |
| | | from UE1 by treating the received | ${R}_{2} > {log}_{2} ( 1 + \frac{{\vert {h}_{12} \vert}^{2} {p}_{2}}{{\vert {h}_{11} \vert}^{2} {p}_{1} + {N}_{0}} )$ | for UE2, UE3 to fulfill | |
| | | interference | | conditions | |
| | | from UE2 as | | on inter- | |
| | | noise, and | | ference | |
| | | performing | | | |
| | | SIC on UE3 | | | |
| | | where first | | | |
| | | the message | | | |
| | | of UE3 is | | | |
| | | decoded, | | | |
| | | and next the | | | |
| | | interference | | | |
| | | from UE3 is | | | |
| | | removed | | | |
| | | from the | | | |
| | | received | | | |
| | | signal before | | | |
| | | decoding the | | | |
| | | message | | | |
| | | from UE1. | | | |
| UE3 | UE2 | Decode the received message | ${R}_{2} < {log}_{2} ( 1 + \frac{{\vert {h}_{12} \vert}^{2} {p}_{2}}{{\vert {h}_{13} \vert}^{2} {p}_{3} + {\vert {h}_{11} \vert}^{2} {p}_{1} + {N}_{0}} )$ | Adapt p₁, p₂, p₃ and MCS index | ${R}_{1} < {log}_{2} ( 1 + \frac{{\vert {h}_{11} \vert}^{2} {p}_{1}}{{\vert {h}_{13} \vert}^{2} {p}_{3} + {N}_{0}} )$ |
| | | from UE1 by treating the received | ${R}_{3} > {log}_{2} ( 1 + \frac{{\vert {h}_{13} \vert}^{2} {p}_{3}}{{\vert {h}_{11} \vert}^{2} {p}_{1} + {N}_{0}} )$ | for UE2, UE3 to fulfill | |
| | | interference | | conditions | |
| | | from UE3 as | | on inter- | |
| | | noise, and | | ference | |
| | | performing | | | |
| | | SIC on UE2 | | | |
| | | where first | | | |
| | | the message | | | |
| | | of UE2 is | | | |
| | | decoded, | | | |
| | | and next the | | | |
| | | interference | | | |
| | | from UE2 is | | | |
| | | removed | | | |
| | | from the | | | |
| | | received | | | |
| | | signal before | | | |
| | | decoding the | | | |
| | | message | | | |
| | | from UE1. | | | |
| | UE2 first UE3 | Decode the message from UE1 by | ${R}_{2} < {log}_{2} ( 1 + \frac{{\vert {h}_{12} \vert}^{2} {p}_{2}}{{\vert {h}_{11} \vert}^{2} {p}_{1} + {\vert {h}_{13} \vert}^{2} {p}_{3} + {N}_{0}} )$ | Adapt p₁, p₂, p₃ and MCS index | ${R}_{1} < {log}_{2} ( 1 + \frac{{\vert {h}_{11} \vert}^{2} {p}_{1}}{{N}_{0}} )$ |
| | second | first performing SIC for UE2 | ${R}_{3} < {log}_{2} ( 1 + \frac{{\vert {h}_{13} \vert}^{2} {p}_{3}}{{\vert {h}_{11} \vert}^{2} {p}_{1} + {N}_{0}} )$ | for UE2, UE3 to fulfill | |
| | | and next | | conditions | |
| | | performing | | on inter- | |
| | | SIC on UE3. | | ference | |
| | UE2 second UE3 | Decode the message from UE1 by | ${R}_{3} < {log}_{2} ( 1 + \frac{{\vert {h}_{13} \vert}^{2} {p}_{3}}{{\vert {h}_{11} \vert}^{2} {p}_{1} + {\vert {h}_{12} \vert}^{2} {p}_{2} + {N}_{0}} )$ | Adapt p₁, p₂, p₃ and MCS index | ${R}_{1} < {log}_{2} ( 1 + \frac{{\vert {h}_{11} \vert}^{2} {p}_{1}}{{N}_{0}} )$ |
| | first | first performing SIC for UE2 | ${R}_{2} < {log}_{2} ( 1 + \frac{{\vert {h}_{12} \vert}^{2} {p}_{2}}{{\vert {h}_{11} \vert}^{2} {p}_{1} + {N}_{0}} )$ | for UE2, UE3 to fulfill | |
| | | and next | | conditions | |
| | | performing | | on inter- | |
| | | SIC on UE3. | | ference | |

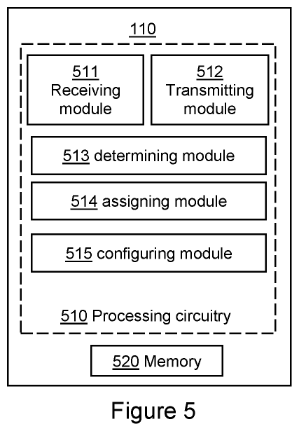

There is also disclosed herein a network node 110 for co-scheduled wireless devices 121 in a wireless communications network. The network node is suitable for decoding uplink transmissions from the co-scheduled wireless devices. FIG. 5 shows a schematic block diagram of embodiments of an access point 110. The schematic block diagram in FIG. 5.

The embodiments of the network node 110 may be considered as independent embodiments or may be considered in any combination with each other. It should also be noted that, although not shown in FIG. 5, the network node may comprise known conventional features for such devices, such as a power source like a battery or mains connection, or an antenna arrangement.

The network node 110 may comprise processing circuitry 510 and a memory 520. The processing circuitry 510 may comprise a receiving module 511 and a transmitting module 512. The receiving module 511 and the transmitting module 512 may comprise radio frequency circuitry and baseband processing circuitry capable of transmitting and receiving a radio signal in the wireless communications network 100. The receiving module 511 and the transmitting module 512 may also form part of a single transceiver. It should also be noted that some or all of the functionality described in the embodiments above as being performed by the network node 110 may be provided by the processing circuitry 510 executing instructions stored on a computer-readable medium, such as, e.g. the memory 520 shown in FIG. 5. Alternative embodiments of the network node 110 may comprise additional components, such as, a determining module 513, an assigning module 514, and/or a configuring module 515, responsible for providing functionality to support the embodiments of the network node described herein.

The network node 110, processing circuitry 510, or determining module 513 is configured to determine a set 122 of wireless devices 121 from a plurality of wireless devices in the wireless communications network 100 for co-scheduled uplink transmission based on obtained uplink transmissions from the plurality of wireless devices. The network node 110, processing circuitry 510, or determining module 513 is further configured to determine a measure of interference for each wireless device 121 in the set 122, where the measure of interference of a wireless device indicates interference from uplink transmissions from said wireless device with respect to uplink transmissions from the remainder of wireless devices in the set 122. The node 110, processing circuitry 510, or arranging module 514 is configured to assign each wireless device 121 in the set 122 into one of at least a first group 123 and a second group 124. Wireless devices with respective measures of interference below a first predetermined threshold are assigned to the first group, and wireless devices with respective measures of interference above a second predetermined threshold are assigned to the second group. The node 110, processing circuitry 510, or configuring module 515 is configured to configure the network node 110 to treat interference from at least one wireless device 121 in the set 122 based on the group 123, 124 to which said wireless device is assigned.

The measure of interference is based on any of channel state information, transmit power, relative location, and modulation and coding scheme of the wireless devices 121 in the set 122.

The network node 110, processing circuitry 510, or assigning module 514 may be configured to assign a wireless device in the set 122 into a third group 125 if the measure of interference of that wireless device is above the first predetermined threshold and is below the second predetermined threshold, where the first predetermined threshold is different from the second predetermined threshold.

The network node 110, processing circuitry 510, or determining module 513 may be configured to determine one or more transmit parameters of at least one wireless device 121 in the set 122 based on the group 123, 124, 125 to which said wireless device is assigned. In that case, the network node 110, or processing circuitry 510 are configured to communicate the one or more determined transmit parameters to the corresponding wireless devices 121 in the set 122 for co-scheduled uplink transmission.

The network node 110, processing circuitry 510, or assigning module 514 may be configured to iteratively assign each wireless device 121 in the set 122 into one of the first, second, and third group 123, 124, 125 based on the one or more determined transmit parameters, and determine one or more determined transmit parameters based on the group assignments.

The assigning and determining steps may be iterated until the number of wireless devices assigned to each group converges. Alternatively, the assigning and determining steps may be iterated until the third group has a number of assigned wireless devices below a predetermined threshold.

The one or more determined transmit parameters of a wireless device 121 in the first group 123 may be determined to decrease the measure of interference of that wireless device, and the one or more determined transmit parameters of a wireless device in the second group 124 may be determined to increase the measure of interference of that wireless device.

The one or more determined transmit parameters of a wireless device 121 in the third group 125 may be determined to decrease the measure of interference of that wireless device if that measure of interference is closer to the first predetermined threshold than the second predetermined threshold, and to increase the measure of interference of that wireless device if that measure of interference is closer to the second predetermined threshold than the first predetermined threshold.

One or more remaining wireless devices 121 in the third group 125 may be removed from the set 122 for co-scheduled uplink transmission.

The one or more determined transmit parameters may comprise any of transmit power, modulation and coding scheme, and a hardware parameter affecting any of digital-to-analog converter resolution, power amplifier linearity, and oscillator phase noise.

The one or more determined transmit parameters may be communicated as part of a scheduling decision. Furthermore, the one or more determined transmit parameters may be communicated separately from a scheduling decision.

The network node 110 or processing circuitry 510 may be configured to decode uplink transmissions from a wireless device 121 in the set 122 where uplink transmissions from other wireless devices in the first group 123 are treated as noise and where uplink transmissions from other wireless devices in the second group 124 are managed using successive interference cancellation.

The set 122 of wireless devices 121 for co-scheduled uplink transmission may be determined based on a measure of compatibility for a predetermined number of wireless devices to be assigned to the set, where the measure of compatibility indicates a compatibility of co-scheduled uplink transmissions.

Alternatively, the set 122 of wireless devices 121 for co-scheduled uplink transmission may be determined by assigning a first wireless device 121 from the plurality of wireless devices to the set 122. Thereafter, iteratively, until a predetermined number of wireless devices are assigned to the set, determining a measure of compatibility for each unassigned wireless device 121 in the plurality of wireless devices, where the measure of compatibility of a wireless device indicates a compatibility of co-scheduled uplink transmissions from said wireless device with respect to uplink transmissions of the one or more wireless devices assigned to the set 122. Thereafter, assigning a wireless device 121 to the set 122 based on the measure of compatibility.

The measure of compatibility may be based on any of channel state information, transmit power, relative location, and modulation and coding scheme of the wireless devices.

The methods disclosed herein may be implemented through one or more processors, such as the processing circuitry 510 in the network node 110 depicted in FIG. 5, together with computer program code for performing the functions and actions of the embodiments herein.

The program code may also be provided as a computer program product, for instance in the form of a data carrier carrying computer program code or code means for performing the embodiments herein when being loaded into the processing circuitry 510 in the network node 110. The computer program code may e.g. be provided as pure program code in the network node 110 or on a server and downloaded to the network node. Thus, it should be noted that the modules of the network node 110 may in some embodiments be implemented as computer programs stored in memory, e.g. in the memory modules 520 in FIG. 5, for execution by processors or processing modules, e.g. the processing circuitry 510 of FIG. 5. Those skilled in the art will also appreciate that the processing circuitry 510 and the memory 520 described above may refer to a combination of analog and digital circuits, and/or one or more processors configured with software and/or firmware, e.g. stored in a memory, that when executed by the one or more processors such as the processing circuitry 510 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

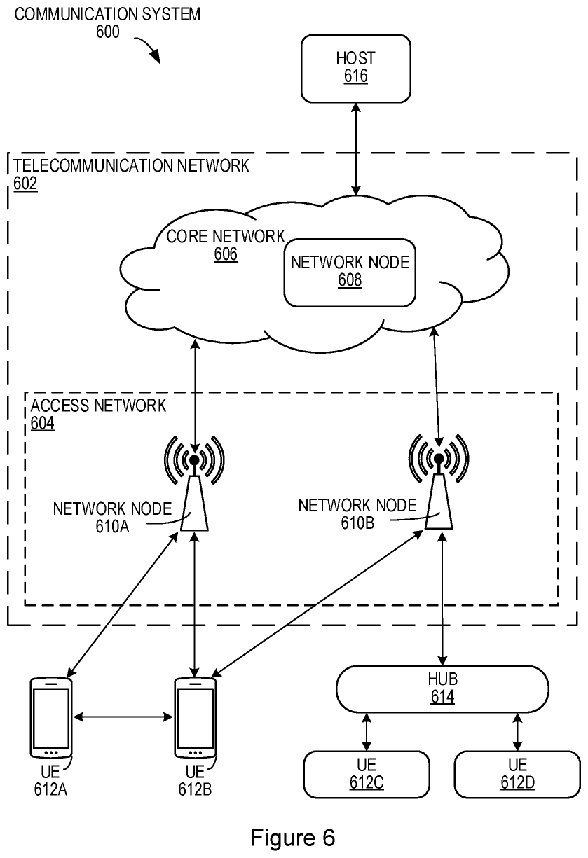

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3rd Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

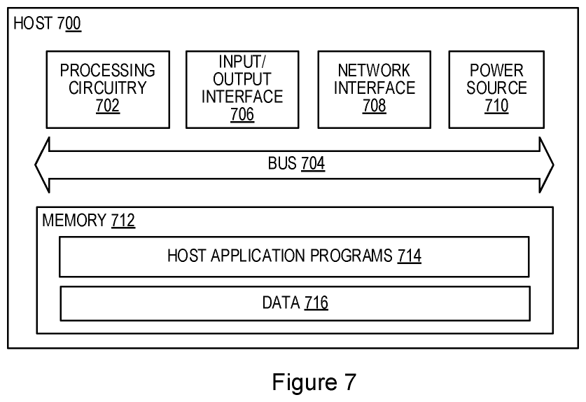

FIG. 7 is a block diagram of a host 700, which may be an embodiment of the host 616 of FIG. 6, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. QQ2 and QQ3, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

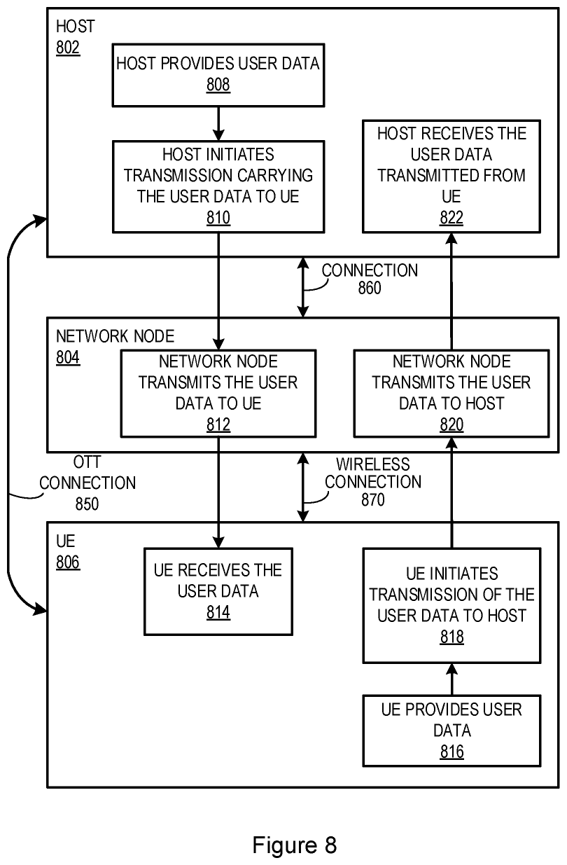

FIG. 8 shows a communication diagram of a host 802 communicating via a network node 804 with a UE 806 over a partially wireless connection in accordance with some embodiments. Example implementations, in accordance with various embodiments, of the UE (such as a UE 612a of FIG. 6 and/or UE QQ200 of Figure QQ2), network node (such as network node 610a of FIG. 6 and/or network node QQ300 of Figure QQ3), and host (such as host 616 of FIG. 6 and/or host 700 of FIG. 7) discussed in the preceding paragraphs will now be described with reference to FIG. 8.

Like host 700, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 606 of FIG. 6) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850. The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application that provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve the performance of the wireless communications network in terms of e.g. throughput and thereby provide benefits such as relaxed restriction on file size and improved content resolution.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

### Additional Aspects

According to a first additional aspect of the embodiments described herein, it is also presented a host configured to operate in a communication system to provide an over-the-top (OTT) service. The host comprises: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE: determine a set 122 of wireless devices 121 from a plurality of wireless devices in the wireless communications network 100 for co-scheduled uplink transmission based on obtained uplink transmissions from the plurality of wireless devices; determine a measure of interference for each wireless device 121 in the set 122, where the measure of interference of a wireless device indicates interference from uplink transmissions from said wireless device with respect to uplink transmissions from the remainder of wireless devices in the set 122; assign each wireless device 121 in the set 122 into one of at least a first group 123 and a second group 124, where wireless devices with respective measures of interference below a first predetermined threshold are assigned to the first group, and where wireless devices with respective measures of interference above a second predetermined threshold are assigned to the second group; and configure the network node 110 to treat interference from at least one wireless device 121 in the set based on the group 123, 124 to which said wireless device is assigned. The processing circuitry of the host may be configured to execute a host application that provides the user data; and the UE may comprise processing circuitry configured to execute a client application associated with the host application to receive the transmission of user data from the host.

According to a second additional aspect of the embodiments described herein, it is also presented a method implemented in a host configured to operate in a communication system that further includes a network node and a user equipment (UE). The method comprises: providing user data for the UE; and initiating a transmission carrying the user data to the UE via a cellular network comprising the network node, wherein the network node performs the following operations to transmit the user data from the host to the UE: determining a set 122 of wireless devices 121 from a plurality of wireless devices in the wireless communications network 100 for co-scheduled uplink transmission based on obtained uplink transmissions from the plurality of wireless devices; determining a measure of interference for each wireless device 121 in the set 122, where the measure of interference of a wireless device indicates interference from uplink transmissions from said wireless device with respect to uplink transmissions from the remainder of wireless devices in the set 122; assigning each wireless device 121 in the set 122 into one of at least a first group 123 and a second group 124, where wireless devices with respective measures of interference below a first predetermined threshold are assigned to the first group, and where wireless devices with respective measures of interference above a second predetermined threshold are assigned to the second group; and configuring the network node 110 to treat interference from at least one wireless device 121 in the set based on the group 123, 124 to which said wireless device is assigned. The method may further comprise, at the network node, transmitting the user data provided by the host for the UE. In the method, the user data may be provided at the host by executing a host application that interacts with a client application executing on the UE, the client application being associated with the host application.

According to a third additional aspect of the embodiments described herein, it is also presented a communication system configured to provide an over-the-top service. The communication system comprises: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform the following operations to transmit the user data from the host to the UE: determine a set 122 of wireless devices 121 from a plurality of wireless devices in the wireless communications network 100 for co-scheduled uplink transmission based on obtained uplink transmissions from the plurality of wireless devices; determine a measure of interference for each wireless device 121 in the set 122, where the measure of interference of a wireless device indicates interference from uplink transmissions from said wireless device with respect to uplink transmissions from the remainder of wireless devices in the set 122; assign each wireless device 121 in the set 122 into one of at least a first group 123 and a second group 124, where wireless devices with respective measures of interference below a first predetermined threshold are assigned to the first group, and where wireless devices with respective measures of interference above a second predetermined threshold are assigned to the second group; and configure the network node 110 to treat interference from at least one wireless device 121 in the set based on the group 123, 124 to which said wireless device is assigned. The communication system may further comprise: the network node; and/or the user equipment. In the communication system, the processing circuitry of the host may be configured to execute a host application, thereby providing the user data; and the host application may be configured to interact with a client application executing on the UE, the client application being associated with the host application.

According to a fourth additional aspect of the embodiments described herein, it is also presented a host configured to operate in a communication system to provide an over-the-top (OTT) service. The host comprises processing circuitry configured to initiate receipt of user data; and a network interface configured to receive the user data from a network node in a cellular network, the network node having a communication interface and processing circuitry, the processing circuitry of the network node configured to perform the following operations to receive the user data from the UE for the host: determine a set 122 of wireless devices 121 from a plurality of wireless devices in the wireless communications network 100 for co-scheduled uplink transmission based on obtained uplink transmissions from the plurality of wireless devices; determine a measure of interference for each wireless device 121 in the set 122, where the measure of interference of a wireless device indicates interference from uplink transmissions from said wireless device with respect to uplink transmissions from the remainder of wireless devices in the set 122; assign each wireless device 121 in the set 122 into one of at least a first group 123 and a second group 124, where wireless devices with respective measures of interference below a first predetermined threshold are assigned to the first group, and where wireless devices with respective measures of interference above a second predetermined threshold are assigned to the second group; and configure the network node 110 to treat interference from at least one wireless device 121 in the set based on the group 123, 124 to which said wireless device is assigned. In the host, the processing circuitry of the host may configured to execute a host application, thereby providing the user data; and the host application may be configured to interact with a client application executing on the UE, the client application being associated with the host application. In the host, the initiating receipt of the user data may comprise requesting the user data.

According to a fifth additional aspect of the embodiments described herein, it is also presented a method implemented by a host configured to operate in a communication system that further includes a network node and a user equipment (UE). The method comprises at the host, initiating receipt of user data from the UE, the user data originating from a transmission which the network node has received from the UE, wherein the network node performs the following operations to receive the user data from the UE for the host: determining a set 122 of wireless devices 121 from a plurality of wireless devices in the wireless communications network 100 for co-scheduled uplink transmission based on obtained uplink transmissions from the plurality of wireless devices; determining a measure of interference for each wireless device 121 in the set 122, where the measure of interference of a wireless device indicates interference from uplink transmissions from said wireless device with respect to uplink transmissions from the remainder of wireless devices in the set 122; assigning each wireless device 121 in the set 122 into one of at least a first group 123 and a second group 124, where wireless devices with respective measures of interference below a first predetermined threshold are assigned to the first group, and where wireless devices with respective measures of interference above a second predetermined threshold are assigned to the second group; and configuring the network node 110 to treat interference from at least one wireless device 121 in the set based on the group 123, 124 to which said wireless device is assigned. The may further comprise at the network node, transmitting the received user data to the host.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware. It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above-described preferred embodiments. Various alternatives, modifications and equivalents may be used. Therefore, the above embodiments should not be construed as limiting.

1. A method performed by a network node in a wireless communications network for configuring the network node for co-scheduled wireless devices in the wireless communications network, the method comprising:
determining a set of wireless devices from a plurality of wireless devices in the wireless communications network for co-scheduled uplink transmission based on obtained uplink transmissions from the plurality of wireless devices;
determining a measure of interference for each wireless device in the set, where the measure of interference of a wireless device indicates interference from uplink transmissions from the wireless device with respect to uplink transmissions from the remainder of wireless devices in the set;
assigning each wireless device in the set into one of at least a first group and a second group, where wireless devices with respective measures of interference below a first predetermined threshold are assigned to the first group, and where wireless devices with respective measures of interference above a second predetermined threshold are assigned to the second group; and
configuring the network node to treat interference from at least one wireless device in the set based on the group to which the wireless device is assigned.

2. The method according to claim 1, wherein the measure of interference is based on any of channel state information, transmit power, relative location, and modulation and coding scheme of the wireless devices in the set.

3. The method according to claim 1, wherein the assigning of wireless devices comprises assigning a wireless device in the set into a third group if the measure of interference of that wireless device is above the first predetermined threshold and is below the second predetermined threshold, where the first predetermined threshold is different from the second predetermined threshold.

4. The method according to claim 1, further comprising:
determining one or more transmit parameters of at least one wireless device in the set based on the group to which the wireless device is assigned, and communicating the one or more determined transmit parameters to the corresponding wireless devices in the set for co-scheduled uplink transmission.

5. The method according to claim 3, further comprising, iteratively assigning each wireless device in the set into one of the first, second, and third group based on the one or more determined transmit parameters, and determining one or more determined transmit parameters based on the group assignments.

6. The method according to claim 5, wherein the assigning and determining steps are iterated until the number of wireless devices assigned to each group converges.

7. The method according to claim 5, wherein the assigning and determining are iterated until the third group has a number of assigned wireless devices below a predetermined threshold.

8. The method according to claim 4, wherein the one or more determined transmit parameters of a wireless device in the first group are determined to decrease the measure of interference of that wireless device, and wherein the one or more determined transmit parameters of a wireless device in the second group are determined to increase the measure of interference of that wireless device.

9. The method according to claim 3, wherein the one or more determined transmit parameters of a wireless device in the third group are determined to decrease the measure of interference of that wireless device if that measure of interference is closer to the first predetermined threshold than the second predetermined threshold, and to increase the measure of interference of that wireless device if that measure of interference is closer to the second predetermined threshold than the first predetermined threshold.

10. The method according to claim 5, wherein one or more remaining wireless devices in the third group are removed from the set for co-scheduled uplink transmission.

11. The method according to claim 4, wherein the one or more determined transmit parameters comprise any of transmit power, modulation and coding scheme, and a hardware parameter affecting any of digital-to-analog converter resolution, power amplifier linearity, and oscillator phase noise.

12. The method according to claim 4, wherein the one or more determined transmit parameters are communicated as part of a scheduling decision.

13. The method according to claim 4, wherein the one or more determined transmit parameters are communicated separately from a scheduling decision.

14. The method according to claim 4, further comprising configuring the network node to decode uplink transmissions from a wireless device in the set where uplink transmissions from other wireless devices in the first group are treated as noise and where uplink transmissions from other wireless devices in the second group are managed using successive interference cancellation.

15. The method according to claim 4, wherein the set of wireless devices for co-scheduled uplink transmission is determined based on a measure of compatibility for a predetermined number of wireless devices to be assigned to the set, where the measure of compatibility indicates a compatibility of co-scheduled uplink transmissions.

16. The method according to claim 1, wherein the set of wireless devices for co-scheduled uplink transmission is determined by assigning a first wireless device from the plurality of wireless devices to the set, and iteratively, until a predetermined number of wireless devices are assigned to the set, determining a measure of compatibility for each unassigned wireless device in the plurality of wireless devices, where the measure of compatibility of a wireless device indicates a compatibility of co-scheduled uplink transmissions from the wireless device with respect to uplink transmissions of the one or more wireless devices assigned to the set; and
assigning a wireless device to the set based on the measure of compatibility.

17. The method according to claim 15, wherein the measure of compatibility is based on any of channel state information, transmit power, relative location, and modulation and coding scheme of the wireless devices.

18. A network node for co-scheduled wireless devices in a wireless communications network, the node comprising a processing circuitry and a memory, the processing circuitry being configured to:
determine a set of wireless devices from a plurality of wireless devices in the wireless communications network for co-scheduled uplink transmission based on obtained uplink transmissions from the plurality of wireless devices;
determine a measure of interference for each wireless device in the set, where the measure of interference of a wireless device indicates interference from uplink transmissions from the wireless device with respect to uplink transmissions from the remainder of wireless devices in the set;
assign each wireless device in the set into one of at least a first group and a second group, where wireless devices with respective measures of interference below a first predetermined threshold are assigned to the first group, and where wireless devices with respective measures of interference above a second predetermined threshold are assigned to the second group; and
configure the network node to treat interference from at least one wireless device in the set based on the group to which the wireless device is assigned.

19. The network node according to claim 18, wherein the measure of interference is based on any of channel state information, transmit power, relative location, and modulation and coding scheme of the wireless devices in the set.

20. The network node according to claim 18, wherein the processing circuitry is configured to assign a wireless device in the set into a third group if the measure of interference of that wireless device is above the first predetermined threshold and is below the second predetermined threshold, where the first predetermined threshold is different from the second predetermined threshold.

21.-36. (canceled)
